(19) United States
(12) Patent Application Publication
(10) Pub. No.: US 2025/0198387 A1
(43) Pub. Date: Jun. 19, 2025

(54) WIND TURBINE POWER TRANSMISSION SYSTEM

(71) Applicant: Vestas Wind Systems A/S, Aarhus N. (DK)

(72) Inventor: Andreas Weber, Dortmund (DE)

(21) Appl. No.: 18/851,240

(22) PCT Filed: Mar. 29, 2022
(86) PCT No.: PCT/EP2022/058335

§ 371 Date: Sep. 26, 2024

(51) Int. Cl. F03D 15/10; F16H 25/06; F16H 55/17

(52) U.S. Cl. CPC F03D 15/101; F16H 25/06; F16H 55/17; F16H 2055/176

(57) ABSTRACT

The invention relates to a wind turbine comprising: a nacelle provided on the top of a tower, a rotor including a hub and a number of blades, a main shaft configured to be driven by the rotor about a main axis and supported on the nacelle, a generator having a generator rotor and generator stator, and a gear system arranged to increase the rotational speed between said rotor and said generator rotor. The gear system comprises: a fixed ring gear, an input member coupled to or driven by the main shaft having a plurality of radially movable tooth segments carried in guiding slots and engageable at outer ends with the ring gear, a central output member within the input member having an outer eccentric profile acted on and driven by inner ends of radially movable tooth segments, whereby rotary movement of the input member drives the radially movable tooth segments through engagement with the ring gear and effects rotation of the central output member.

### FIELD OF THE INVENTION

The present invention relates to power transmission systems for wind turbines. More specifically, the present invention relates to wind turbines comprising a new type of gearbox.

### BACKGROUND OF THE INVENTION

Wind turbines typically include a rotor with large blades driven by the wind. The blades convert the kinetic energy of the wind into rotational mechanical energy. The mechanical energy usually drives one or more generators to produce electrical power. Thus, wind turbines include a power transmission system to process and convert the rotational mechanical energy into electrical energy. The power transmission system is sometimes referred to as the “power train” of the wind turbine. The portion of a power transmission system from the rotor to the generator is referred to as the drivetrain.

Oftentimes it is necessary to increase the rotational speed of the rotor to the speed required by the generator(s). This is accomplished by a gearbox between the rotor and generator. Thus, the gearbox forms part of the power train and converts a low-speed, high-torque input from the rotor into a lower-torque, higher-speed output for the generator. Wind turbines with medium or high speed generators usually utilize gearboxes providing gear ratios between i=30 and i=140, requiring gearboxes with two or three gear stages, which may be epicyclical gear states alone or in combination with parallel gear stages. These gears come with a certain VOC (=volume of control, i.e. how much volume is used), weight, thus costs and a given efficiency. It is desired to find alternative types of gearboxes where a higher gear ratio per VOC/weight can be achieved in the high torque domain of modern wind turbine technology.

U.S. Pat. No. 8,656,809B2 and U.S. Pat. No. 8,256,327B2 disclose an alternative type of gear system including radially moving teeth and building further on technology from e.g. WO99/36711, both utilised to reduce a high electrical motor speed down to the low speed needed for e.g. a tool machine function (step-down). For ease of reference, the technology as described in U.S. Pat. No. 8,656,809B2 and U.S. Pat. No. 8,256,327B2 will hereafter be referred to radial-moving-teeth design.

With this radial-moving-teeth design, intuitively it is expected to only be operable as step-down gearing, in similar way to a worm drive. Indeed, the disclosure of U.S. Pat. No. 8,656,809B2 is as a step-down gear, where it is mentioned that with the radial-moving-teeth design it is possible to freely select a very high drive-input-side rotational speed range up to approximately 6000 rpm, and further that it is possible to freely select transmission ratios of approximately i=10 to i=200.

With the present invention the inventor has realized that the radial-moving-teeth design technology can be used for step-up gearing as well and that it is particularly advantageous in gearboxes for wind turbines to obtain compact wind turbine transmission systems.

### SUMMARY OF THE INVENTION

The invention relates to a wind turbine comprising: a nacelle provided on the top of a tower, a rotor including a hub and a number of blades, a main shaft configured to be driven by the rotor about a main axis and supported on the nacelle, a generator having a generator rotor and generator stator, and a gear system arranged to increase the rotational speed between said rotor and said generator rotor. The gear system comprises: a fixed ring gear, an input member coupled to or driven by the main shaft having a plurality of radially movable tooth segments carried in guiding slots and engageable at outer ends with the ring gear, a central output member within the input member having an outer eccentric profile acted on and driven by inner ends of radially movable tooth segments, whereby rotary movement of the input member drives the radially movable tooth segments through engagement with the ring gear and effects rotation of the central output member.

The radial-moving-teeth design introduces new basic principles compared to traditional gears used in wind turbines. Instead of rotating gears, a large number of single tooth segments is used to connect between input and output, ensuring a multiple utilisation of each tooth segment during one rotation around the centre. This provides a gear system that can handle gear ratios between 10 and around 100 in one stage with a particularly high power density and stiffness. Furthermore, the gear system is very compact with an excellent power-to-size ratio.

A key point in the use of the radial-moving-teeth design in machine tools in the power range of a few kW is that the system comes without backlash. For machine tools and robotics, extremely precise positioning is required which does not allow any backlash, and furthermore backlash may be damaging due to potential vibrations.

With the present invention, the inventor has discovered that on the contrary, for a purpose in wind turbines in MW class, the loading of the gears is much more controlled, and the gears will never, in operational mode, be in contact with reverse flanks. Therefore, in wind turbines, backlash is advantageously introduced by taking back the non-load tooth flank and thereby finetuning to optimize efficiency.

Compared to a typical wind turbine gearbox comprising traditional gears, to get the same ratio with the radial-moving-teeth design system, significant savings in VOC may be seen. In general, considering power density and VOC tremendous advantages have been seen. As the interior parts are made of standard steels as usually used in gearboxes together with standard hardening processes, the costs per kg will be similar to today's gearboxes, at least after rolling out the technology.

An additional feature highly advantageous for the use in wind turbines is that the radial-moving-teeth design offers unique possibilities to drive scalability i.a. by:
1. for given torque reducing outer diameter by providing multiple rows of tooth segments
2. Scaling torque by number of tooth segments
3. Scaling torque by number of tooth rows

An additional feature highly advantageous for the use in wind turbines is that the radial-moving-teeth design exhibits beneficial noise and vibration characteristics.

In preferred embodiments of the invention, said input member is an annular input member, i.e. a generally ring-shaped member. Further, the tooth segments are mounted such that they can be displaced radially outwards and inwards within guiding slots in the input member.

In an embodiment of the invention, each radially movable tooth segment is connected to a tilting pad through a flexible connection, preferably a cylindrical-joint-like connection; said tilting pad being adapted for sliding along said output member. In other embodiments, a ball-joint-like connection may also be applicable.

In an embodiment of the invention, the output member is generally circular in cross-section with at least one eccentricity, preferably at least two eccentricities. In various embodiments, the output member has at least one eccentricity on which the radially movable tooth segments act when the radially movable tooth segments are moved into corresponding toothings in the ring gear when rotation of the input member occurs in order to transmit torques and to set a selectable transmission ratio. In various embodiments, the number of eccentricities can be at least two or at least three, even at least four. Hereby it is possible to set or vary a transmission ratio. This transmission ratio may also be adjustable by means of different number of tooth segments and different number of internal toothings of the ring gear. The number of toothings in the ring gear (also referred to as gear sections) may be between 20 and 200, optionally between 30 and 120. The range may also be between 40 and 110, or between 50 and 100, or between 60 and 90, or between 70 and 80. Preferably, there is a difference in number between toothings in the ring gear and tooth segments. Preferably the difference between the number of tooth segments and the toothings in the ring gear is between 2 and 5.

In an embodiment of the invention, said output member is coupled to at least one further gear stage, such as one parallel gear stage. The present invention allows for the new gear system to stand alone as the full gearbox or to be coupled together with well-known gear stages, such as planetary gear stages or parallel gear stages. Any combination of such are also within the scope of the present invention.

In an embodiment of the invention, backlash is allowed between the non-loaded flank and the rear flank of the ring gear. In already known systems using the radial-moving-teeth design, precision is essential, and no backlash is allowed. In wind turbines, this is not the case which may allow for simpler and longer-lasting designs. This backlash may e.g. be at least 0.5 mm along the circumferential direction, such as at least 1 mm.

In some examples, it may be acceptable, or indeed desirable to configure the components of the gearbox such that a controlled degree of backlash is present. For example this may be achieved by configuring the shape of the cam profile on the output shaft accordingly, or by controlling dimensions of the gear tooth segments/elements, and the intermeshing gear profile of the ring gear.

In an embodiment of the invention, said gear system has a speed-increasing transmission ratio between i=10 and i=150, preferably between i=20 and i=75, such as between 25 and 50. In other embodiments of the invention, the gear system has a speed increasing ratio between i=26 and i=49.

In an embodiment of the invention, said gear system has a number of radially movable tooth segments between 10 and 200, preferably between 40 and 100. In another embodiment of the invention, the gear system has a number of radially movable tooth segments between 41 and 99.

In an embodiment of the invention, said gear system has at least two rows of radially movable tooth segments, such as at least three rows. In various embodiments, the number of rows could be one single, as shown in the figures, but also 2, 3, 4 or 5 may have find a huge benefit in enabling flexibility to use same elements with various torque levels. In some embodiments, the number of radially movable tooth segments per row is between 12 and 60. In other embodiments, the number of radially movable tooth segments per row is between 13 and 59, and preferably between 13 and 39, or between 41 and 59.

In an embodiment of the invention, the diameter of said ring gear is between 1000 mm and 3500 mm, preferably between 1500 mm and 2500 mm.

In an embodiment of the invention, said movable tooth segments are cylindrical with a diameter of between 10 and 20 cm, and with a length between 20 and 50 cm. Needless to say, the dimensions involved within wind are much higher than for tooling. In tooling a typical tooth segment diameter is max 2 cm with a length of max 5 cm.

In an embodiment of the invention, an outer tooth flank contour of a tooth flank of the tooth segments and/or a flank contour of a toothing of an internal toothing of said ring gear have/has, in relation to a gear set axis, a tooth contour which makes surface contact possible in an engagement region, wherein the surface contact is achieved by the design as a logarithmic spiral. A benefit of the radial-moving-teeth design is that they do not utilize the involute tooth flank as normally used, but instead a flank contour following a logarithmic spiral. Hereby a larger surface contact can be achieved in the engagement regions.

In an embodiment of the invention, regardless of a selected radius of the gear set axis (M), the outer tooth flank contour of the flank region of the tooth segment and the flank contour of the internal toothing system of the toothing system of the ring gear correspond to a common logarithmic spiral (Ln) with a pitch angle (α).

In an embodiment of the invention, during the stroke movement of the tooth segments, there is a uniform load distribution, as the tooth segments are displaced along the logarithmic spiral (Ln) and those tooth flanks of the tooth segments and the ring gear internal toothing which are in contact with one another always have the same pitch angle (α).

In an embodiment of the invention, the pitch angle (α) is between 15° and 75°, such as between 20° and 40°. In other embodiments, (α) may be between 30° and 60°.

In an embodiment of the invention, the tooth segments have a tip curve, which bear tangentially against the tooth flank and merges into the outer tooth flank contour thereof.

In an embodiment of the invention, a ring gear root fillet is provided between the respective flank contours of the internal toothing of the ring gear, wherein the ring gear root fillet is less curved than a tip curve of the tooth segments.

In an embodiment of the invention, a coating is used in at least one of the following interfaces: tooth segment to ring gear, tooth segment to input member, and tilting pad to output member. Friction loss may be lowered through the use of a coating in appropriate contact surfaces.

In an embodiment of the invention, said wind turbine has a nominal power of at least 2 MW, such as at least 4 MW. In other embodiments, the wind turbine has a nominal power of at least 4.1 MW.

In an embodiment of the invention, said wind turbine further comprises:
a support structure including at least one bearing supporting the main shaft for rotation about the main axis and constraining other movements;
wherein said gear system has a gearbox housing rigidly coupled to the support structure.

In an embodiment of the invention, the support structure further includes a bearing housing surrounding the at least one bearing, the gearbox housing being suspended from said bearing housing.

As mentioned, a generator is connected to said output member. A generator has a generator rotor and a generator stator within a generator housing, and in preferred embodiments, the generator housing is rigidly coupled to and suspended from the gearbox housing, but in other embodiments, the generator housing could instead be positioned adjacent the gearbox with said generator rotor being connected to said output member.

In an embodiment of the invention, the at least one bearing comprises a first bearing and a second bearing spaced apart within the bearing housing.

In an embodiment of the invention, said ring gear is integrated with or rigidly coupled to said bearing housing and said input member is integrated with or rigidly coupled to said main shaft.

In an embodiment of the invention, said gear system is fully integrated within said bearing housing such that said ring gear, along the rotational axis of the main shaft, is positioned between said first bearing and said second bearing.

Even though the present gear system is very compact in itself, an even more compact solution may be obtained through fully integrating the gear system into the bearing housing. In such a solution, a generator could be positioned directly behind the bearing housing.

One particular advantage of the gear system of the invention is that it avoids the inherent design characteristics of spur-gear based transmissions which use helix angles for various technical reasons, e.g. to improve force transmission and to reduce NVH (noise, vibration, harshness) generation. However, in the context of a wind turbine gearbox the helix angles on spur gears can present a challenge particularly when the gearbox is driven in reverse, e.g. by a rotor turner tool which may occur during wind turbine installation, since it can result in undesirable axial forces being generated. Since the gearbox as described herein does not require helix angles, it may be a beneficial gearbox design particularly during rotor blade installation.

### BRIEF DESCRIPTION OF THE DRAWINGS

The above and other aspects of the invention will now be described, by way of example only, with reference to the accompanying drawings, in which:

FIG. 1 is a perspective view of one example of a wind turbine,

FIG. 2 is a perspective view of a power transmission system for the wind turbine of FIG. 1,

FIG. 3 is a cross-sectional view of the power transmission system of FIG. 2,

FIG. 4 is a perspective view of a power transmission system according to an embodiment of the present invention,

FIG. 5 is an exploded perspective view of a gearbox in the power transmission system shown in FIG. 4;

FIG. 6 is a view transversely through the gearbox showing the arrangement of main components;

FIGS. 7a-c are a series of views showing a gear tooth element of the gearbox and an associated pivot/tilt pad;

FIGS. 8a-c are a series of views that show the progress of one of the gear tooth elements of the gearbox during a load cycle;

FIG. 9 shows a diagrammatically illustrated plan view of an embodiment of a contour of a tooth flank and an internal toothing system of a ring gear,

FIG. 10 shows a diagrammatically illustrated enlarged detail in the tooth region of FIG. 6; and

FIG. 11 shows an alternative embodiment of the present invention.

Note that features that are the same or similar in different drawings are denoted by like reference signs.

### DETAILED DESCRIPTION OF THE DRAWINGS

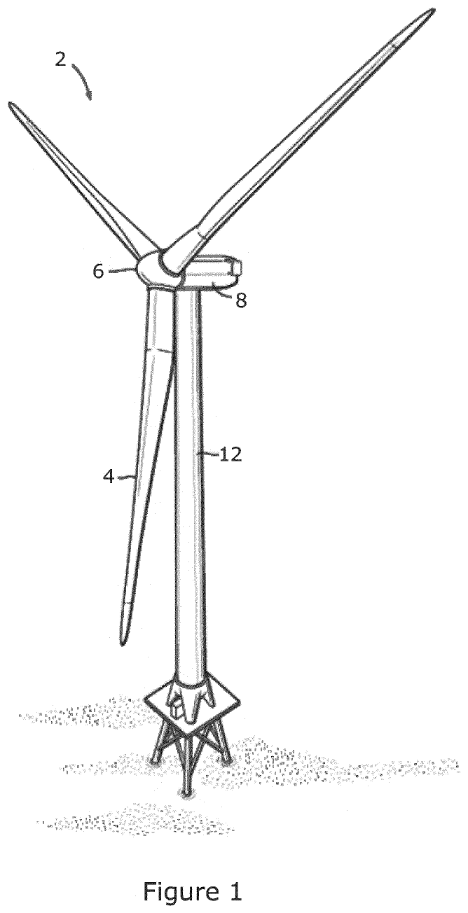

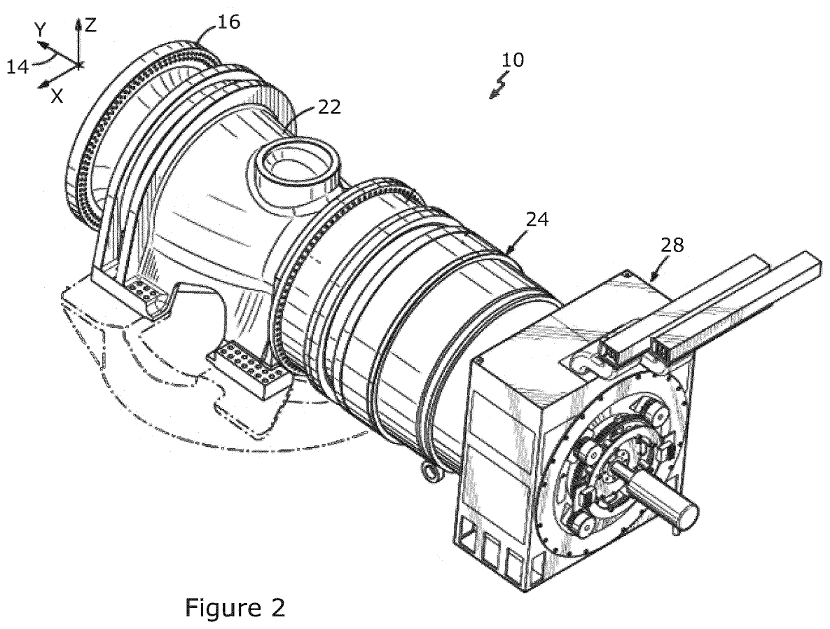

FIG. 1 shows one example of a wind turbine 2. Although an offshore wind turbine is shown, it should be noted that the description below may be applicable to other types of wind turbines as well. The wind turbine 2 includes a rotor including blades 4 mounted to a hub 6, which is supported by a nacelle 8 on a tower 12. Wind causes the rotor (blades 4 and hub 6) to rotate about a main axis 14 (FIG. 2). This rotational energy is delivered to a power transmission system (or “power train”) 10 housed within the nacelle 8.

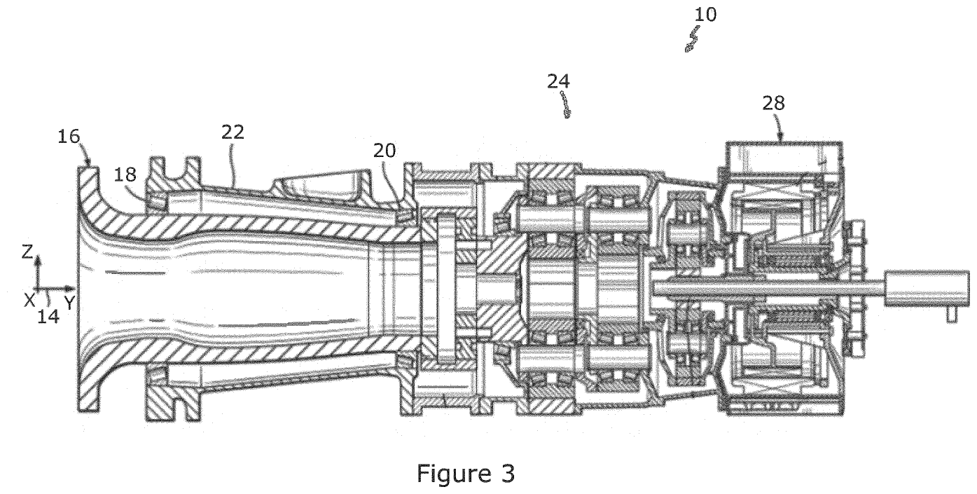

FIGS. 2 and 3 shows a prior art power transmission system 10 including a main shaft 16 coupled to the hub 6 (FIG. 1). The power transmission system 10 also includes first and second bearings 18, 20 supporting the main shaft 16, a bearing housing 22 surrounding the first and second bearings 18, 20, and a gearbox 24 having an input member driven by the main shaft 16. The gearbox 24 increases the rotational speed between the main shaft 16 and the generator 28. It should be noted that the elements shown in FIGS. 1-3, such as rotor, hub 6, main shaft 16, and nacelle 8 are shown as examples only, and these may vary in design within the scope of the present invention.

The type of input member depends on the particular gearbox design. Shown in FIG. 3 is a prior art gearbox with the use of a planet carrier of the first planetary stage, wherein the ring gear is fixed to the housing, which results in the sun gear increasing the rotational speed to transfer to the next stage of the gearbox.

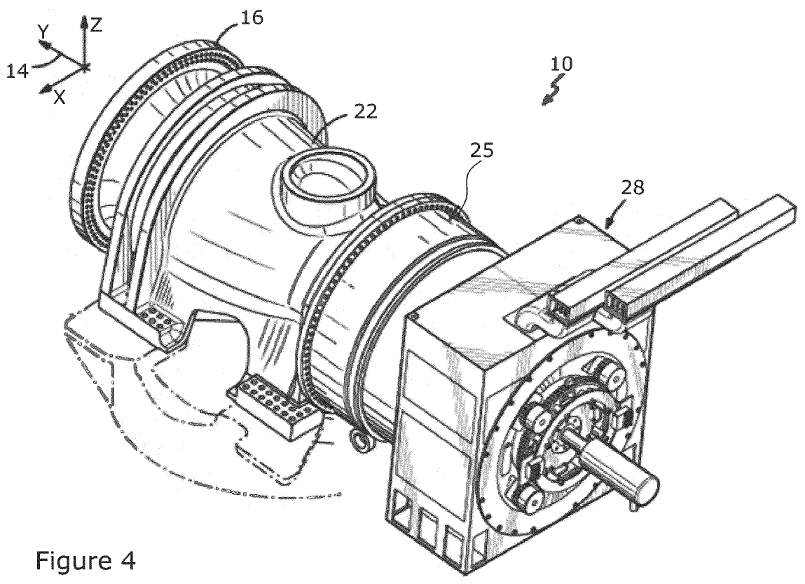

FIG. 4 shows a power transmission system 10 similar to the prior art system in FIG. 2, but now with the prior art gearbox 24 replaced with a gear system 25 according to the present invention including the radial-moving-teeth design gear. It is noted that the other components of the power transmission system are identical, namely the generator 28 and the bearing housing 22 including the main shaft 16. It is noted that in spite of the much lower axial width of the new gear system compared to the prior art gearbox, the transmission ratio of the gearboxes of FIGS. 2 and 4 are comparable. Thus, it is even visually clear that the new gearbox including radial-moving-teeth design gears provides a huge saving in volume and consequently also weight of the gearbox as compared to traditional gearboxes in wind turbines.

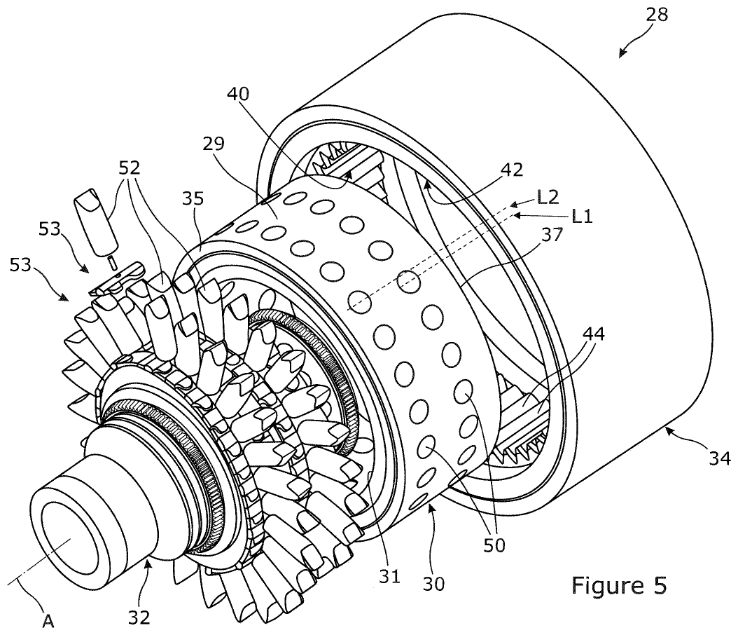

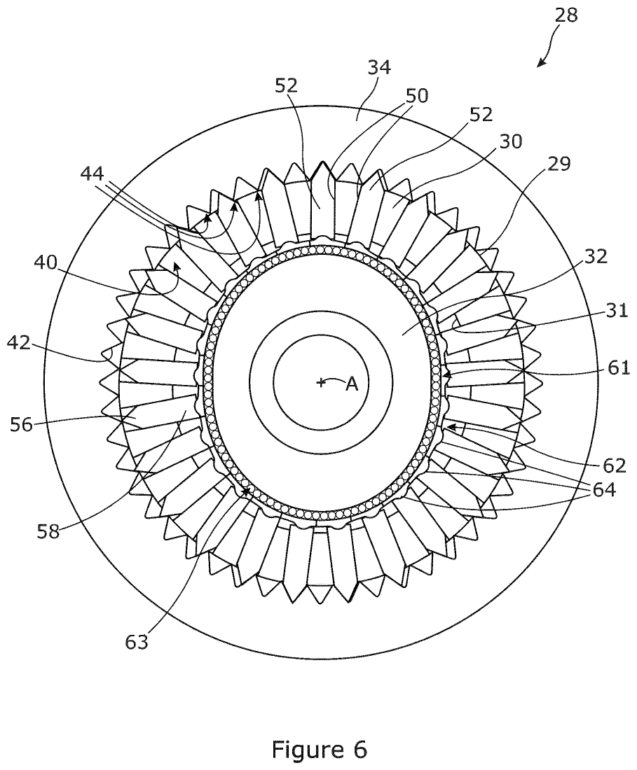

Aspects of the gearbox are shown in more detail in FIG. 5 and FIG. 6. FIG. 5 illustrates the general arrangement of various components of the gearbox 25, as an exploded view, whilst FIG. 6 shows the relative positioning of the internal components of the gearbox.

The gearbox 25 comprises three main components: an input drive member 30, hereinafter referred to as the ‘tooth carrier’, an output drive member 32, and an outer gear ring 34. The gearbox 25 is configured to increase the speed of rotation between the input drive member 30 and the output drive member 32. In this context, the tooth carrier 30 would be coupled to the main rotor shaft 20 of the wind turbine, and the output drive member 32 would be coupled to a rotor of the electrical generator 26. The tooth carrier 30 therefore represents the input shaft of the gearbox 25.

The main components of the transmission as discussed above may be made of a suitable material, for example a suitable grade of cast or forged steel, for example bearing steels or gear steels. In lower load applications, the components may be made from other materials such as suitable engineering plastics. The selection of the exact material for a particular application would be within the abilities of a skilled person. Suitable hardening processes may also be employed to obtain the required material characteristics, e.g. for tribological and/or corrosion resistant purposes. Instead of or in addition to hardening processes such as case hardening, low friction or hardened coatings may be used for any of the components of the gearbox. For example, suitable coating processes include black oxide coatings, diamond-like carbon (DLC) coatings, physical vapor deposition (PVD) coatings, and arc wire spray coatings. Such coating processes may be used for wear hardening and corrosion protection. Such coatings and processes may be applied to at least one of the ring gear, the tooth segments, the carrier member, and the pivot pads.

It is also envisaged that different internal components of the gear system could be made of different materials, or the same materials but processed in different ways so as to alter their physical characteristics. For example, in some embodiments of the invention the gear tooth segments may be fabricated from a steel (e.g. gear steel or bearing steel) which is suited for gearbox applications and processed suitably using case hardening processes. The tilting pads may also be made from steel but suitably processed with a different hardening process so the steel is softer. Alternatively, the tooth segments may be made from a steel that is of a harder grade than the grade of steel used for the tilting pads. Still alternatively, the tooth segments may be made from a steel having a hardness grade that is lower than the grade of steel used for the tilting pads.

Still further, the tooth segments may be made from a lighter weight material such as aluminium or magnesium which have been suitable strengthened by a coating or by an application of laser hardening. Furthermore, it is envisaged that a composite material may be used such as a fibre reinforced polymer, the fibres being any suitable strengthening fibre such as carbon fibres or aramid fibres.

At this point it should be noted that the general arrangement of the transmission is similar to the so-called “Galaxie” (®) drive system manufactured by Wittenstein Group. This type of system is sometimes referred to in the art as a ‘radial-moving-tooth’ or ‘slidable tooth’ design, and fundamentals of the technology are described in U.S. Pat. No. 8,656,809B2 and U.S. Pat. No. 8,256,327B2, amongst others. However, such drive systems tend to be used in speed reduction applications with lighter loading and with relatively short working lives, whereas in the current context the intention is for the transmission to be used in high loading applications as a speed increaser to convert the relatively high torque and low speed input drive from the main rotor of the wind turbine (approx. 5-15 rpm) to a lower torque but higher speed output drive for the gearbox (approximately 100-1000 rpm). Moreover, in wind turbine applications, gearboxes tend to be in operation for longer time periods compared to other applications, for example usually wind turbines have a working life of 25 years.

Returning to FIGS. 5 and 6, the outer gear ring 34 is a rotationally fixed component which is associated with or formed as part of a main housing (not shown) of the gearbox 25. Therefore, the outer gear ring 34 is in a fixed relation to the nacelle of the wind turbine.

The outer gear ring 34 is configured to define an internal gear profile 40 about its radial interior surface 42. The gear profile 40 extends circumferentially about the rotational axis of the gearbox 25. The gear profile 40 is defined by a plurality of gear tooth sections 44 or more simply ‘gear sections’.

It should be noted that the outer profile of each gear section 44 may be shaped to define part of a logarithmic profile, which is a benefit in terms of force transmission with tooth elements of the transmission, as will be discussed later.

The tooth carrier 30 is configured to rotate within the space defined by the outer gear ring 34. The tooth carrier 30 is associated with and is physically connected to the main shaft of the wind turbine and so rotates at the same speed. It should be appreciated that the tooth carrier 30 is not shown connected to the main shaft in the drawings. However, the tooth carrier 30 comprises a set of bolt holes on its axial surface which serve to define a connecting interface for the main shaft, or to an intermediate coupling member to couple the tooth carrier 30 to the main shaft.

The tooth carrier 30 is annular in form and defines a radially outer facing surface 29, a radially inward facing surface 31, and first and second axial facing surfaces, 35,37. The tooth carrier 30 is configured to define a circumferentially-spaced arrangement of apertures, bores or holes 50, each of which accommodates a respective gear tooth element or segment 52. The apertures 50 therefore act as guides for the respective tooth elements 52.

The radial depth/dimension of the apertures 50 are slightly less than the axial length of the gear tooth element so that the tips of the gear tooth elements protrudes from the top surface of the tooth carrier 30. It should be noted that only two of the gear tooth elements 52 and respective apertures 50 are labelled in FIG. 5 so as not to obscure detail in the Figure. The precise number of gear tooth elements 52 and respective apertures 50 is not the subject of this invention and so will not be described in detail here. However, the number may vary between about 20 and 200. Moreover, the number of gear tooth elements and gear sections may be selected to vary the gear ratio between the tooth carrier 30 and the output member 32, and also to select the relative direction of rotation between the tooth carrier 30 and the output member 32.

The number of gear sections 44 in the ring gear 34 may be in the range of 20 to 200. In other examples the number of gear sections 44 may be in the range of 30 to 120. In other examples the number of gear sections 44 may be in the range of 40 to 110. In other examples the number of gear sections 44 may be in the range of 50 to 100 or 60 to 90, or 70 to 80.

As is known generally in the art, the tooth carrier 30 and the output member 32 may rotate in the same direction, albeit at different rotational speeds, or they may rotate in opposite directions, and the direction of rotation is determined by the relative number of gear tooth elements 52 in the tooth carrier 30 and the number of gear sections 44 in the outer gear ring 34. Reference is made to U.S. Ser. No. 10/830,328 which discusses more details relating to the interrelation between the number of gear sections 44 and the number of slidable tooth elements 52.

It is envisaged that the tooth elements may be formed such that the width is in the range of 10.1 and 19.9 cm. Furthermore, the tooth elements may be formed such that the length along the tooth axis is between 20.1 cm and 49.9 cm.

The tooth carrier 30 may be configured to have a single row of apertures 50 and gear tooth elements 52. However, in the illustrated example the tooth carrier 30 has two rows 53 of apertures 50 and gear tooth elements 52, spaced appropriately along the axial direction of the gearbox. Further rows are possible, although not currently envisaged. In this context, the discussion above about the numbers of teeth in a row, would apply to each row. Note that the rotational axis of the transmission is indicated in FIGS. 5 and 6 as ‘A’.

As shown in FIG. 5, each row of apertures 50 is spaced circumferentially about the tooth carrier 30 in an angularly equi-spaced relationship. The angular interval between apertures 50 in the rows is the same for each row in the illustrated embodiment, and may be between 2 and 20 degrees, for example, depending on the number of tooth elements. However, in theory there may be different numbers of apertures 50, and therefore tooth elements 52, in each row. In the illustrated example, where there are equal numbers of apertures 50 and tooth elements 52 in the rows, the apertures 50 in one row are angularly shifted from the apertures 50 in the other one of the rows. Therefore, the apertures 50 in one row are axially misaligned with the apertures of the adjacent row. This can be appreciated by observing the line L1 which is taken through the centre of one of the apertures 50 in one of the rows, and line L2 which is taken through the centre of the nearest aperture 50 in the other row. As can be seen, there is a small angular shift between the apertures 50 in the two rows. The angular shift may be up to 50% of the angular interval between adjacent apertures 50. For example, the angular shift may be 5% or 10% or 20% or 30% or 40% of the angular interval between a neighbouring two apertures 50 in a particular row. For example, for a row with 30 apertures, the angular interval would be 12 degrees. The angular shift between apertures in adjacent rows may therefore be up to 6 degrees.

The rotating action of the tooth carrier 30 causes the respective gear tooth elements 52 to be driven radially inwardly by the gear profile 40 since they are slidable within the apertures 50. Since the number of gear tooth elements 52 does not match the number of gear sections 44 of the gear profile 40, the result is that each of the gear tooth elements 52 is at a different radial lift height within its respective aperture 50. This imparts a wave-like pattern of motion of the gear tooth elements 52 which in turn imparts a rotational drive force to the output member 32, as will now be described.

Referring to the gear tooth elements 52 in more detail, and also with reference to FIGS. 5a-c, it will be seen that each gear tooth element 52 includes a tooth tip region 56 and a tooth base region 58, both of which are aligned on a tooth axis B. The tooth tip region 56 is positioned radially outwardly with respect to the tooth base 58. Although not seen clearly in FIGS. 5 and 6, it should be appreciated that the shape of the tooth tip region 56 is configured to compliment the shape of the respective gear section 44 of the outer ring gear 34. Each flank 60 of a tooth tip region 56 may shaped to define a substantially flat surface, in the illustrated example, although in other examples the flanks may define a part of a logarithmic spiral or have some degree of curvature.

Whereas the tooth tip regions 56 of the gear tooth elements 52 engage with the gear profile 40 of the outer ring member 34, the tooth base regions 58 of the gear tooth elements 52 engage with the output member 32.

As can be seen in FIG. 6 particularly well, the output member 32 has a non-circular shaped circumferential outer surface 61. More specifically the shape is oval in the illustrated example. The output member 32 is therefore cam-shaped in form so as to provide a shaft cam drive with two cam peaks, in this example. Other examples may provide a single cam peak or more than two cam peaks. It is the eccentric shape of the output drive member 32 that allows the gear tooth elements 52 to drive it with a rotational motion.

In the illustrated example with two rows of apertures 50 and tooth elements 52, it follows that there are also two cam surfaces 61, one for each row. Each cam surface will be axially spaced along the direction of the rotational axis. The two cam surfaces may have dissimilar profiles. In this situation, the two cam surfaces are configured such that their cam peaks are angularly offset from one another, but otherwise the cam surfaces are identical. This angular offset may be the same as the angular offset between adjacent rows of apertures 50, or it may be different. Currently, it is envisaged that the angular offset between the two cam surfaces may be up to 90 degrees. For example, the angular offset may be 5 degrees, or 10 degrees, or 20, 30, 40, 50, 60, 70, 80 or 90 degrees. Other angular offsets between the stated examples are also envisaged.

In order to reduce friction between the gear tooth elements 52 and the output drive member 32, there is provided a bearing arrangement 62.

The bearing arrangement 62 comprises a plurality of pivot pads or tilting pads 64, only some of which are labelled in FIG. 6. Each of the pivot pads 64 is associated with a respective one of the gear tooth elements 52 and acts as a fulcrum against which bears a respective base region 58 of a gear tooth element 52. The gear tooth elements 52 therefore engage the cam surface of the output member 52 to transmit a force thereto thereby acting on and driving the output member 32. However, the tooth element 52 act on the cam surface indirectly in this example by bearing against the pivot pads 64, although the term ‘engage’, ‘act on’ and ‘driven by’ in this context are considers to cover both direct engagement and also indirect engagement via the pivot pads or other functionally equivalent bearing type element.

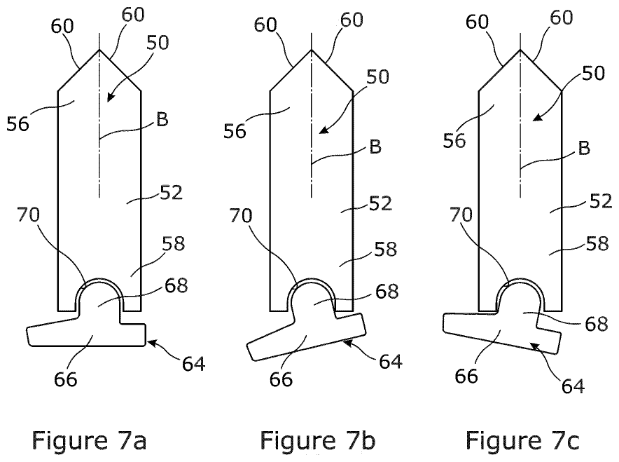

The action of a pivot pad 64 is shown schematically in FIGS. 7a-c. As can be seen the pivot pad 64 includes a pad portion 66 and a pivot or fulcrum portion 68. The pivot portion 68 protrudes upwardly from the pad portion 66 and is shaped to complement a recess 70 defined in the underside of the base region 58 of the gear tooth element 52. The pivot portion 68 may define a part-spherical or part-cylindrical protrusion. The precise geometry is not crucial to the Invention but it should allow the pivot pad 64 to pivot smoothly with respect to the gear tooth element 52, as can be seen in the Figures, in which FIG. 7a shows the pivot pad 64 in a neutral position, and FIGS. 7b and 7c show the pivot pad 64 tilted to the left and to the right, respectively.

The pivot pads 64 are arranged to extend about the circumferential outer surface of the output member 32. Each pivot pad 64 is associated with a respective gear tooth element 52. Since the pivot pads 64 slide on the outer surface of the output member 32, a suitable means may preferably be provided to aid lubrication between those components. This may be fulfilled by a low friction coating on the underside of the pivot pads 64 and/or a low friction coating on the outer surface of the output member 32. Alternatively, the pivot pads 64 may be mounted on a suitable lubricating strip (c.f. FIG. 5) or roller bearing train (c.f. FIG. 6). The pivot pads 64 may be suitably coupled to one other. To constrain the pivot pads from moving about on the output drive member 32 in the axial direction, the pivot pads 64 may be received in a shallow guide channel (not shown) defined in the outer surface of the output member 32, or other functionally similar arrangement.

The benefit of the pivot pads is that they transmit the linear driving force vectors generated by the individual tooth elements more effectively into the cam-like surface of the output member 32 as that surface undulates beneath the pivot pad 64. The pivot pads ensure that the force from a radially inward motion of a tooth segment is distributed over a larger area on the output shaft/element. The pivot pads are tiltable to follow the eccentricity of the output shaft in all rotational positions of the output shaft. The pivot pads each feature a cylinder thereby creating a cylindrical-joint-like connection to each separate tooth segment with a corresponding indentation in the radially innermost part of the tooth segment. Further, the tilting pads have a sliding surface touching the output shaft. The sliding surface on the tilting pad may be realised by a coating or a layer with a material with a low friction coefficient on the tilting pad. Alternatively, a specific separate sliding pad may be attached to the tilting pad. Alternatively, the complete tilting pad may be manufactured from a material with a low friction coefficient. In some embodiments, the tilting pads are connected to each other establishing a ring structure, whereas in other embodiments they are simply positioned next to each other, thereby filling out the full circumference of the output shaft.

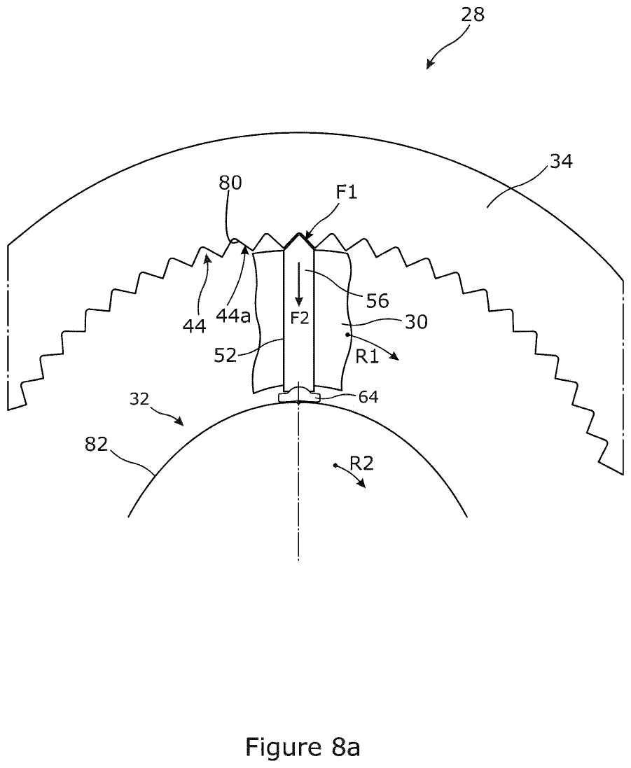

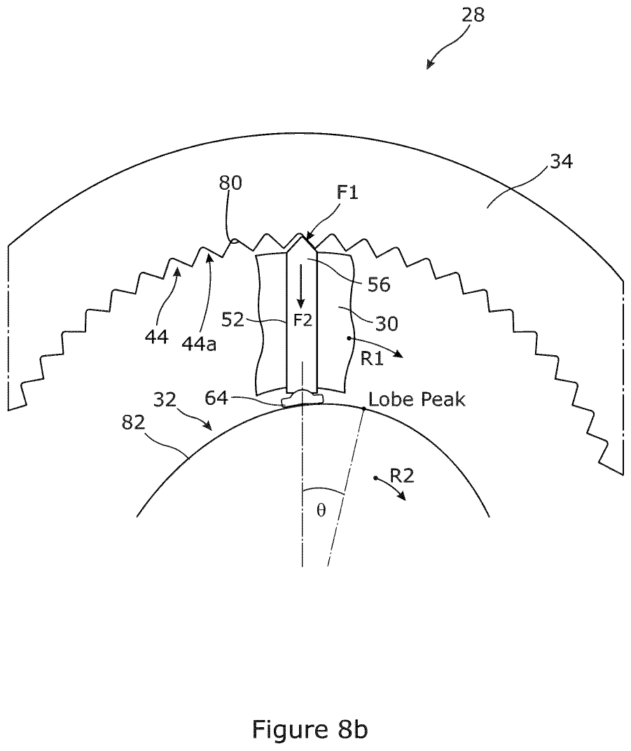

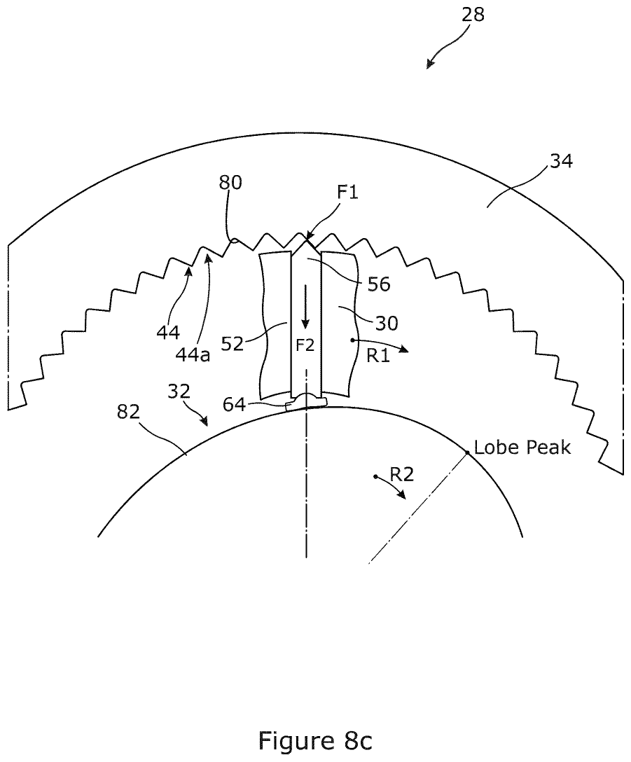

The above discussion provides an overview of the components of the gearbox 25 and its functionality. By way of further explanation of the way in which the gear tooth elements 52 move within the tooth carrier 30 during rotation thereof, reference will now be made to FIG. 8a to 8c. FIGS. 8a to 8c are a sequence of drawings that illustrates a short rotational phase of the tooth carrier 30 and the output member 32. In these Figures, only a single one of the gear tooth elements 52 are shown for the sake of clarity. However, from viewing FIGS. 8a to 8c, the relative movement of the tooth carrier 30 and the gear tooth element 52 is apparent, as is the effect that the force applied to the gear tooth element 52 has on the output member 32.

Referring firstly to FIG. 8a, this can be considered a reference position at the start of a tooth loading cycle where the tip region 56 of the gear tooth element 52 is located in a trough 44a of a gear tooth section 44. It should be noted that the outer ring gear 34 is stationary, whilst the tooth carrier 30 and the output member 32 rotate relative to it, but at different rotational speeds. The direction of rotation of the input drive member 30 is labelled as R1 in FIG. 8a, and can be seen as being clockwise in this example. Similarly, the direction of rotation of the output member 32 is labelled as R2, and is also clockwise, in this example. As noted above, the tooth carrier 30 and output member 32 may be configured to rotate in opposite directions in some examples.

At this point, it will be noticed the movement of the tooth carrier 30 can be appreciated by the movement of the gear tooth element 52 relative to the outer gear ring 34 by comparing the position of the gear tooth element 52 with the gear section 44 with which it is engaged in FIGS. 8a-8d. Notably, in FIG. 8a the output member 32 is in a rotational position at which the height of the cam shape is at a maximum. The cam shape provided by the output member 32 can therefore be considered as in a top dead centre position in FIG. 8a.

As the tooth carrier 30 is driven in a clockwise direction, a force will be exerted on the tip region 56 of the gear tooth element 52 by a rising flank 80 of the gear tooth section 44. This force is shown on FIG. 8a as F1. A component of force F1 will be in the vertically downwards direction (in the orientation of the drawings), and is shown here as F2. The gear tooth element 52 will therefore start to exert a force on the cam shaped surface of the output drive member 32 via the pivot pad 64 as the output member 32 rotates, and as the gear tooth element 52 passes the top position as shown in FIG. 8a.

Comparing FIG. 8b with FIG. 8a, it will be seen in FIG. 8b that the output member 32 has rotated in the clockwise direction by an angle Θ of about 30 degrees. Conversely, the gear tooth element 52 has only moved relative to the outer ring member 34 by a small fraction of a degree, which illustrates the speed increasing configuration of the gearbox 25.

As can be seen, the cam shape of the output member 32 has changed position in FIG. 8b such that the vertical force F2 applied by the gear tooth element 52 via the pivot pad 64 now acts on a falling slope 82 of the cam shape. The gear tooth element 52, therefore contributes a rotational force to the output member 32, which combines with the forces generated by the other gear tooth elements to drive the output member 32 in rotation.

FIG. 8c is substantially the same as FIGS. 8a and 8b, although shows the gear tooth element 52 a step further along its loading cycle. Once the gear tooth element 52 has gone through a load cycle, as shown, it is driven outwardly by the cam surface of the output member 32 and is not loaded during this movement.

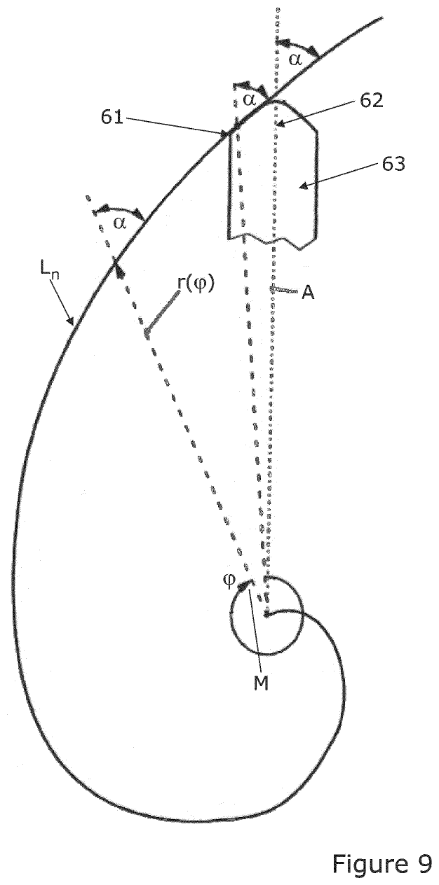

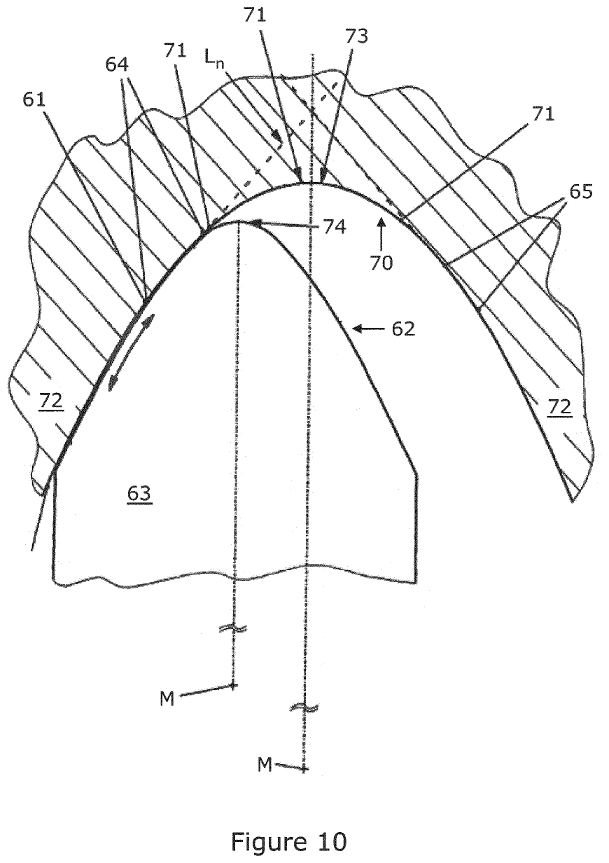

As has been discussed above, the flanks of the gear tooth elements 32 may be substantially flat surfaces although some curvature is expected to be beneficial in terms of the transmission of force between the tip region 56 and the gear sections 44. In some examples, as also discussed above, the flanks may be shaped so as to define a logarithmic spiral. FIGS. 9 and 10 give diagrammatic illustrations of a logarithmic spiral Ln which originates from a gear set axis M of a coaxial gear set R. The logarithmic spiral Ln can have any desired pitch angle α.

An outer tooth flank contour 161, 162 of the tooth elements 52 and an inner tooth flank contour 164 and 165 of the gear section 44 are preferably adapted to the contour or the course of the logarithmic spiral Ln as a function of a constant pitch angle α. Here is shown that both tooth flank contours 161, 162 and 164, 165 are mirror symmetrical with respect to a center axis A. However, this needs not be the case for wind turbines, where the gearbox need not be able to move in both directions.

Independently of the selected radius r, each radii, starting from the gear set axis M of the coaxial gear set R, intersects the tooth flank contour 161 or 162 and 164 or 165 at an identical pitch angle α. The pitch angle α can be selected freely or is defined by the function of the selected logarithmic spiral Ln.

The displacement of the tooth elements 52 along the logarithmic spiral Ln with their tooth flanks 161 and 162 with respect to the tooth flanks 164 and 165, respectively, of the internal gear section 44, results in flank regions of the same pitch angle α always being opposite each other. As a consequence, a very good tooth face contact is always present.

This results in that no linear rolling takes place as in standard gears, but instead a flat displacement between the tooth element 52 and the internal gear section 44 of the outer gear ring 34 which provides very high torque transmission with smaller wear than in standard gears.

Moreover, a ring gear root fillet 171, adapted tangentially with a contour to the contour 164 and 165 of the outer gear ring 34, is formed between two adjacent toothing systems 172 in the region of the tooth root 173 of the internal gear section 44.

The curvature here is preferably less than a tip curve 174 of the tooth element 52. The tip curve 174 of the tooth element 52 is adapted in a tangentially merging manner to the tooth flank contours 161, 162 of the tooth flanks. Hereby a transition with low jolt is ensured between the individual up and down movements of the tooth segments 163.

The contact area is sought to be as large as possible to transmit the largest possible forces and moments, especially in the region of a toothing system 172 of the outer gear ring 34. Additionally, because of the stroke movement of the tooth elements 52 with low jolt, pushing back of the tooth elements 52 takes place automatically as a result of the design of the tooth flank contour.

A preferred part of the invention is that an outer contour of tooth segments, in particular in the region of the tooth flanks, follows the contour of a logarithmic spiral. The logarithmic spiral denotes a curve which intersects all the radii emanating from the origin at the same pitch angle α. Its course is defined by the formula:

r=e\hat{ }aα,

where: tan α=1/a and a is a real constant, a>0.

This pitch angle α can be selected as desired between 15° and 75°, such as between 30° and 60°, by the corresponding function of the logarithmic spiral, with the result that different tooth flank geometries of the internal toothing system and of the tooth elements can also be influenced. In other embodiments, the pitch angle α can be selected as desired between 15° and 45°, such as between 20° and 40° or between 25° and 35°.

This contour is also used as the contour of a toothing system, in particular an internal toothing system of the outer gear ring 34. Hereby a full surface contact between one tooth flank contour of the tooth element and the tooth flank contour of the toothing system is achieved in the engagement region of both tooth flanks of the tooth element with the toothing system of the outer gear ring.

The logarithmic spiral geometry ensures full surface contact during the radial movement of the tooth segment into the internal toothing system of the outer gear ring, independently of radius and size of the gear. Further an optimum load distribution (pressure distribution) is obtained, with the result that a very good transmission of high torque may be possible. Furthermore, the wear may be lower than traditional wind turbine gearboxes, and not least the resulting wear will be uniform to the flank surfaces. This may result in a longer lifetime and less service needed, which is of very high importance in wind turbine industry, where downtime should be avoided as much as possible.

Provided that there are z2=80 tooth elements/segments on the outer gear ring and the centre shaft features z1=two eccentric maxima the gearing ratio between the carrier 53 and shaft 55 calculates to

$${i}_{System} = \frac{z 2}{z 1} = \frac{80}{2} = 40$$

Each tooth element 52 has a line contact with the internal toothing system of the ring gear (see FIG. 7) that due to the flank contour following a logarithmic spiral develops as a full hydrodynamic contact, i.e. surface contact is used instead of linear contact. There is no rolling contact as known from involute gears. Each tooth element can align contact to the ring gear around its own axis due to the cylindrical shape of the tooth element and the pivot pad. Thereby an ideal load distribution factor can be reached, similarly to Khβ=1.0 in an involute gear, where the usual value is around 1.15.

It is to be noted that the short lever of the forces between the heads of the tooth elements 52 and the supporting tooth carrier 30 is one reason for the extreme stiffness of this gear design, which provides a positive effect on the dynamics of a wind turbine.

In preferred embodiments, the output member 32 is arranged radially within and coaxially with the tooth carrier 30 forming the input member.

The desired transmission ratio can be chosen by means of the selection of a different number of tooth elements in relation to the toothings of the outer gear ring 34 or the output member 32, in particular also by means of the selection of an outer contour of the output member 32. It is possible to select or set the transmission ratio in particular by means of the selection of the different tooth engagements or by means of the different number of engagements of the tooth elements.

It is to be noted that the gearbox with radial-moving-teeth design as shown herein may advantageously be combined with standard gearboxes used in wind turbines. For instance, combining one radial-moving-teeth design stage with one parallel stage, or with two parallel gear stages. Even combinations with planetary stages may be used if desired.

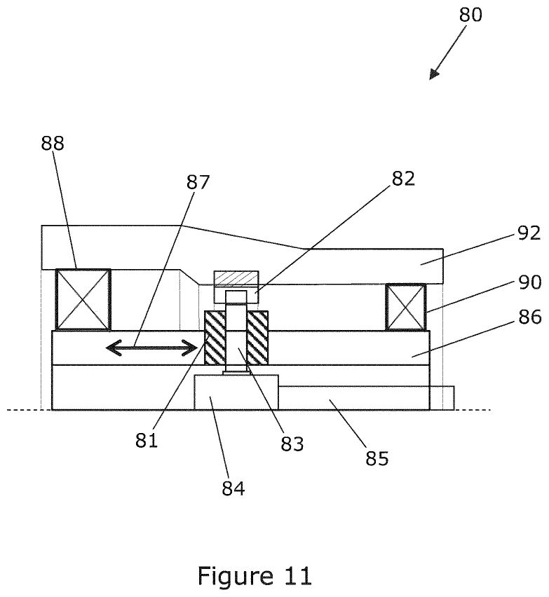

FIG. 11 discloses an alternative embodiment, making the wind turbine power transmission system even more compact than in FIG. 4. Here instead the new gearbox is integrated fully into the main shaft/bearing housing.

Similarly to FIG. 3, the power transmission system 80 includes first and second bearings 88, 90 supporting the main shaft 86, and a bearing housing 92 surrounding the first and second bearings 88, 90. In this embodiment, the gearbox is integrated into the power transmission system, such that the main shaft 86 is directly fixed to and rotates with the tooth carrier 81 inside the bearing housing 92. The gearbox works similarly to the principles as described above with a ring gear 82 fixed to or integrated with the bearing housing 92, radially moving tooth segments/elements 83, thereby increasing the rotational speed of the output shaft eccentric section 84 compared to the rotational speed of the main shaft. This eccentric section 84 is coupled to or integrated with the output shaft 85, which is then further be coupled to a generator (not shown). Further, bearings (not shown) for the output shaft 85 will be present, for instance between the output shaft 85 and the main shaft 86.

The ring gear 82 is designed as an integral part of the bearing housing 92, the necessary toothing being machined into the bearing housing 92. Alternatively, the ring gear 82 may be flanged or bolted into the bearing housing 92 as a separate part, for instance by including machined grooves in the bearing housing 92 to accept the ring gear 82. Connections via semi-elastic elements to equalize deflections and/or dampen noise may also be possible.

The tooth carrier 81 may be designed as an integral part of the main shaft 86. The bores for the tooth segments 83 can be radially machined into the main shaft 86. It is as well possible to have the tooth carrier 81 as a separate part and connect it in between two parts of the main shaft 86.

The axial position of the gear system 25 in the bearing housing may be set based on desire. Dependent on the size of the system and other parameters, the ideal axial position may change, and can be adjusted accordingly as shown, 87. In one embodiment, the position of the gear system 25 is between 30% and 70% of the distance between the first and second bearings 88, 90. In other embodiments, the position of the gear system 25 is less than 25% of the distance between the first and second bearings 88, 90 from either of them.

The embodiments described above are merely examples of the invention defined by the claims that appear below. Those skilled in the design of wind turbines will appreciate additional examples, modifications, and advantages based on the description. In light of the above, the details of any particular embodiment should not be seen to necessarily limit the scope of the claims below.

1. A wind turbine, comprising:
a nacelle provided on the top of a tower;
a rotor including a hub and a number of blades,
a main shaft configured to be driven by the rotor about a main axis and supported on the nacelle,
a generator having a generator rotor and generator stator, and
a gear system arranged to increase the rotational speed between said rotor and said generator rotor;
wherein the gear system comprises:
a fixed ring gear,
an input member coupled to or driven by the main shaft having a plurality of radially movable tooth segments carried in guiding slots and engageable at outer ends with the ring gear, and
a central output member within the input member having an outer eccentric profile acted on and driven by inner ends of radially movable tooth segments,
whereby rotary movement of the input member drives the radially movable tooth segments through engagement with the ring gear and effects rotation of the central output member.

2. A wind turbine according to claim 1, wherein said input member is an annular input member.

3. A wind turbine according to claim 1, wherein each radially movable tooth segment is connected to a tilting pad through a flexible connection, preferably a cylindrical-joint-like connection; said tilting pad being adapted for sliding along said output member.

4. A wind turbine according to claim 1, wherein the output member is generally circular in cross-section with at least one eccentricity, preferably at least two eccentricities.

5. A wind turbine according to claim 1, wherein said output member is coupled to at least one further gear stage, such as one parallel gear stage.

6. A wind turbine according to claim 1, wherein the gear system exhibits backlash between the non-loaded flank and the rear flank of the ring gear.

7. A wind turbine according to claim 1, wherein said gear system has a speed-increasing transmission ratio between i=10 and i=150.

8. A wind turbine according to claim 1, wherein the gear system has a speed increasing transmission ratio between i=26 and i=49.

9. A wind turbine according to claim 1, wherein said gear system has a number of radially movable tooth segments between 10 and 200.

10. A wind turbine according to claim 1, wherein said gear system has at least one row of radially movable tooth segments, and wherein the number of radially movable tooth segments per row is between 12 and 60.

11. A wind turbine according to claim 1, wherein said gear system has at least one row of radially movable tooth segments, and wherein the number of radially movable tooth segments per row is between 13 and 39 or between 41 and 59.

12. A wind turbine according to claim 1, wherein said gear system has at least two rows of radially movable tooth segments.

13. A wind turbine according to claim 12, wherein each row of radially movable tooth segments is associated with, and therefore exerts a driving force on, a respective cam profile of the central output member, wherein each respective cam profile is shaped differently from the other cam profile.

14. A wind turbine according to claim 12, wherein each row of radially movable tooth segments is associated with, and therefore exerts a driving force on, a respective cam profile of the central output member, wherein each respective cam profile is shaped identically to the other cam profile but are angularly offset therefrom about the rotational axis of the central output member.

15. A wind turbine according to claim 14, wherein the angular offset between cam profiles is between 10 and 90 degrees.

16. A wind turbine according to claim 12, wherein each row of radially movable tooth segments is associated with a respective row of guiding slots, and wherein the guiding slots of one row are axially misaligned with guiding slots of another row.

17. A wind turbine according to claim 16, wherein there are the same number of equi-angularly spaced guiding slots in each row, and wherein the guiding slots of one row are angularly offset from the guiding slots in another row.

18. A wind turbine according to claim 17, wherein the angular offset between guiding slots in each row is up to 50% of the angular interval between adjacent guiding slots within a row.

19. A wind turbine according to claim 1, wherein the diameter of said ring gear is between 1000 mm and 3500 mm.

20. A wind turbine according to claim 1, wherein said movable tooth segments are cylindrical with a diameter of between 10 and 20 cm, and with a length between 20 and 50 cm.

21. A wind turbine according to claim 1, wherein the ring gear comprises a plurality of individual gear sections in the range of 20 to 200.

22. A wind turbine according to claim 1, wherein said movable tooth segments are cylindrical with a diameter between 10.1 cm and 19.9 cm.

23. A wind turbine according to claim 1, wherein said movable tooth segments are cylindrical with a length between 20.1 cm and 49.9 cm.

24. A wind turbine according to claim 1, wherein an outer tooth flank contour of a tooth flank of the tooth segments and/or a flank contour of a toothing of an internal toothing of said ring gear have/has, in relation to a gear set axis, a tooth contour which makes surface contact possible in an engagement region, wherein the surface contact is achieved by the design as a logarithmic spiral.

25. A wind turbine according to claim 1, wherein, regardless of a selected radius of the gear set axis, the outer tooth flank contour of the flank region of the tooth segment and the flank contour of the internal toothing system of the toothing system of the ring gear correspond to a common logarithmic spiral with a pitch angle.

26. A wind turbine according to claim 1, wherein the pitch angle is between 15° and 750°.

27. A wind turbine according to claim 1, wherein a coating is used in at least one of the following interfaces: tooth segment to ring gear, tooth segment to input member, and tilting pad to output member.

28. A wind turbine according to claim 27, wherein the coating includes at least one of a black oxide coating, a diamond-like coating, an arc-wire spray coating, and a physical-vapour deposition applied coating.

29. A wind turbine according to claim 1, wherein said wind turbine has a nominal power of at least 2MW.

30. A wind turbine according to claim 1, wherein said wind turbine has a nominal power of at least 4.1 MW.

31. A wind turbine according to claim 1, further comprising:
a support structure including at least one bearing supporting the main shaft for rotation about the main axis and constraining other movements;
wherein said gear system has a gearbox housing rigidly coupled to the support structure.

32. A wind turbine according to claim 31, wherein the support structure further includes a bearing housing surrounding the at least one bearing, the gearbox housing being suspended from said bearing housing.

33. A wind turbine according to claim 32, wherein the at least one bearing comprises a first bearing and a second bearing spaced apart within the bearing housing.

34. A wind turbine according to claim 32, wherein said ring gear is integrated with or rigidly coupled to said bearing housing and said input member is integrated with or rigidly coupled to said main shaft.

35. A wind turbine according to claim 32, wherein said gear system is fully integrated within said bearing housing such that said ring gear, along the rotational axis of the main shaft, is positioned between said first bearing and said second bearing.
